(19) United States
(12) Patent Application Publication
(10) Pub. No.: US 2008/0231742 A1
(43) Pub. Date: Sep. 25, 2008

(54) IMAGE PICKUP APPARATUS

(75) Inventor: Hiroyuki KURASE, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/039,260

(22) Filed: Feb. 28, 2008

(30) Foreign Application Priority Data
Mar. 19, 2007 (JP) 2007-071027

(51) Int. Cl. H04N 5/222

(52) U.S. Cl. 348/333.01; 348/371; 348/E05.022

(57) ABSTRACT

An image pickup apparatus is disclosed which includes: an image pickup unit that picks up a shooting object; an illuminating unit that illuminates the shooting object; a specifying unit that specifies a range of illumination by the illuminating unit; an illumination range image generating unit that generates an image of the range of illumination which shows the range of illumination specified by the specifying unit. An image is generated by superimposing the image of the shooting object picked up by the image pickup unit and the image of the range of illumination generated by the illumination range image generating unit, so that the generated superimposed image is displayed.

### CROSS-REFERENCE TO RELATED APPLICATION

This application claims priority under 35 USC 119 from Japanese Patent Application No. 2007-71027, the disclosure of which is incorporated by reference herein.

### BACKGROUND

1. Technical Field

The present invention relates to an image pickup apparatus and, more specifically, to an image pickup apparatus having an illuminating unit for illuminating light to a shooting object.

2. Related Art

When taking a picture with a shooting object illuminated with light such as a strobe light, it is important to make adequate exposure of the shooting object. JP-A No. 2002-341416 discloses a technology in which that adjustment of brightness of flash light can be confirmed by combining the background image which is not illuminated with the flash light with the image of the principal shooting object which is illuminated with the flash light.

JP-A No. 5-181181 discloses a technology in which the exposure of two principal shooting objects is made to be adequate by changing the light-emitting amount according to the distance to the shooting object and according to a positional relationship using two strobe lights which are different in light distribution.

In the above technical background, when the strobe light is separated from a camera body, such as the case of an external strobe light, range of illumination of the strobe light is important when taking a picture.

The range of illumination is especially important when shooting in a studio or shooting under water, locations where an external strobe light is used very often. For example, in the case of underwater photography, the strobe light is placed at a position that is separated from the camera to avoid the flash light from being reflected by floating substances in the water, which makes the photos appear as if it is snowing.

When the range of illumination of the strobe light can be changed not only when the strobe light is positioned apart from the camera, as in the case shown above, but also when the strobe light is fixed to the camera, it is difficult to specify the range of illumination of the strobe light before shooting because the range of illumination of the strobe light is not coupled to the angle of the field of view of the camera.

### SUMMARY

In view of the problems as described above, it is an object of the invention to provide an image pickup apparatus which is capable of specifying a range of illumination.

According to a first aspect of the invention, there is provided an image pickup apparatus including: an image pickup unit that picks up an image of a shooting object; an illuminating unit that illuminates the shooting object; a specifying unit that specifies a range of illumination by the illuminating unit; an illumination range image generating unit that generates an image of the range of illumination which shows the range of illumination specified by the specifying unit; a superimposed image generating unit that generates an image by superimposing an image of the shooting object picked up by the image pickup unit and the image of the range of illumination generated by the illumination range image generating unit; and a display unit that displays the superimposed image generated by the superimposed image generating unit.

The image pickup apparatus according to the first aspect may be configured such that: the image pickup unit picks up the image of the shooting object; the illuminating unit illuminates the shooting object; the specifying unit specifies the range of illumination illuminated by the illuminating unit; the illumination range image generating unit generates the image of the range of illumination which shows the range of illumination specified by the specifying unit; the superimposed image generating unit generates the image by superimposing the image of the shooting object picked up by the image pickup unit and the image of the range of illumination generated by the illumination range image generating unit; and the display unit displays the superimposed image generated by the superimposed image generating unit, whereby the range of illumination may be specified.

According to a second aspect of the invention, the image pickup apparatus according to the first aspect further includes: a position acquiring unit that acquires the position of the illuminating unit; an illumination direction acquiring unit that acquires the direction of illumination of the illuminating unit; and a distance measuring unit that measures the distance between the shooting object and the image pickup apparatus; wherein the specifying unit specifies the range of illumination on the basis of the position of the illuminating unit acquired by the position acquiring unit, the direction of illumination acquired by the illumination direction acquiring unit and the distance measured by the distance measuring unit.

The image pickup apparatus according to the second aspect of the invention may be configured such that the range of illumination may be specified on the basis of the position of the illuminating unit, the direction of illumination of the illuminating unit, and the distance between the shooting object and the image pickup apparatus.

According to a third aspect of the invention, the image pickup apparatus according to the second aspect further includes an image pickup sensitivity acquiring unit that acquires an image pickup sensitivity of the image pickup unit, wherein the specifying unit specifies the range of illumination on the basis of the image pickup sensitivity acquired by the image pickup sensitivity acquiring unit.

The image pickup apparatus according to the third aspect of the invention may be configured such that the range of illumination may be specified according to the image pickup sensitivity.

According to a fourth aspect of the invention, in the image pickup apparatus according to the second aspect, the information on the range of illumination is information obtained by dividing the image of shooting object into sections and indicates by section whether or not the image of the shooting object acquired by the image pickup unit is illuminated.

The image pickup apparatus according to the fourth aspect of the invention may be configured such that whether or not the image of shooting object is illuminated is determined for each of the sections which are obtained by dividing the image of the shooting object, so that the load of the process may be reduced than in a case in which whether or not the entire image is illuminated or not is determined.

According to a fifth aspect of the invention, the image pickup apparatus according to the first aspect further includes an auxiliary illuminating unit that illuminates the range of illumination, wherein the specifying unit specifies the range of illumination on the basis of the image picked up by an image pickup unit in a state in which the shooting object is illuminated by the auxiliary illuminating unit and an image picked up by the image pickup unit in a state in which the shooting object is not illuminated by the auxiliary illuminating unit.

The apparatus according to the fifth aspect of the invention may be configured so as to be capable of specifying the range of illumination easily by using the image which is actually illuminated.

According to a sixth aspect of the invention, in the image pickup apparatus according to the second aspect: the information on the range of illumination includes light intensity distribution information that indicates a distribution of the light intensity within the range of illumination; and the display unit displays the distribution of the light intensity within the range of illumination on the basis of the light intensity distribution information.

The image pickup apparatus according to the sixth aspect of the invention may be configured so as to be capable of visualizing not only the range of illumination but also the light intensity.

According to a seventh aspect of the invention, in the image pickup apparatus according to the second aspect: the illuminating unit is capable of changing the size of the range of illumination by the illuminating unit; and the size of the range of illumination indicated by the information on the range of illumination is changed in conjunction with the size of the range of illumination by the illuminating unit.

The image pickup apparatus according to the seventh aspect of the invention may be configured to be capable of specifying the range of illumination also in the case of the illuminating unit which is capable of changing the size of the range of illumination.

Other aspects, features and advantages of the invention will become apparent from the following description taken in conjunction with accompanying drawings.

### BRIEF DESCRIPTION OF THE DRAWINGS

FIG. 1 illustrates an image pickup apparatus according to an exemplary embodiment of the invention;

FIG. 2 illustrates an appearance configuration of a digital camera according to an exemplary embodiment of the invention;

FIG. 3 illustrates a principal configuration of an electric system of the digital camera according to an exemplary embodiment of the invention;

FIG. 4 illustrates a three-dimensional space including the digital camera and a shooting object;

FIG. 5 is a flowchart showing a basic information acquiring process;

FIG. 6A illustrates an XZ plane when viewing the image pickup apparatus from above;

FIG. 6B illustrates a YZ plane when viewing the image pickup apparatus from the side;

FIG. 7 illustrates a positional relationship among a shooting plane, a strobe light and a determination coordinate;

FIG. 8 is a lookup table;

FIG. 9A illustrates a range of illumination of the strobe light;

FIG. 9B illustrates the range of illumination of the strobe light;

FIG. 10 is a flowchart showing a light intensity calculating process;

FIG. 11 is a flowchart showing an entire process in the exemplary embodiment;

FIG. 12A illustrates an example of display of the range of illumination;

FIG. 12B illustrates an example of display of the range of illumination;

FIG. 12C illustrates an example of display of the range of illumination;

FIG. 13 is a flowchart showing a first illumination range specifying process;

FIG. 14 is a flowchart showing a second illumination range specifying process;

FIG. 15A illustrates an example of display of the range of illumination on the basis of divided sections;

FIG. 15B illustrates an example of display of the range of illumination on the basis of divided sections;

FIG. 16 is a flowchart showing a third illumination range specifying process;

FIG. 17A illustrates a range of illumination changing in conjunction with the size of the range of illumination of the strobe light;

FIG. 17B illustrates the range of illumination changing in conjunction with the size of the range of illumination of the strobe light;

FIG. 18 is a flowchart showing a fourth illumination range specifying process;

FIG. 19A illustrates a range of illumination according to an ISO sensitiveness;

FIG. 19B illustrates the range of illumination according to the ISO sensitiveness;

FIG. 20 illustrates a configuration in which auxiliary light is provided in the image pickup apparatus;

FIG. 21 is a block diagram showing a flow of process when the auxiliary light is used; and

FIG. 22 is a flowchart showing a fifth illumination range specifying process.

### DETAILED DESCRIPTION

Referring now to the drawings, exemplary embodiments of the invention will be described in detail.

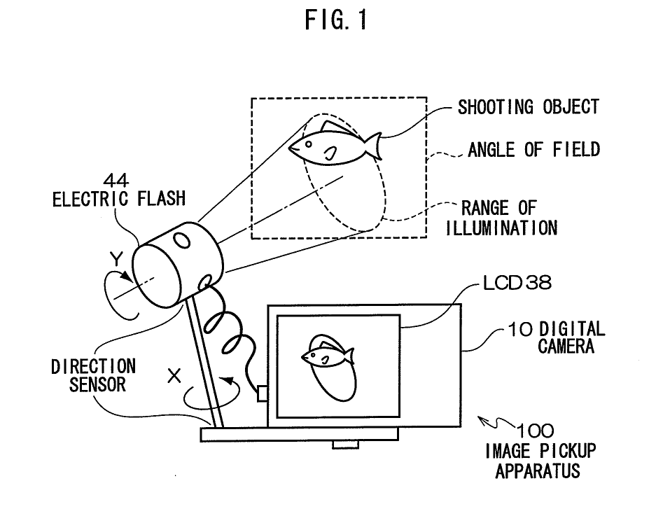

Referring now to FIG. 1, an image pickup apparatus according to an exemplary embodiment of the invention will be described. An image pickup apparatus 100 includes a digital camera 10 and a strobe light 44 as an illuminating unit. The digital camera 10 is provided with an LCD (liquid crystal display) 38, described later, and is capable of displaying a moving image (through image) obtained by consecutive image pickup. The strobe light 44 is capable of notifying the direction of illumination to the digital camera 10. More specifically, the strobe light 44 is provided with two direction sensors, and the lateral angle indicated by an arrow X and the vertical angle indicated by an arrow Y are detected thereby, so that the direction of illumination is specified on the basis of the two angles.

As illustrated in FIG. 1, a shooting object and the range of illumination of the strobe light 44 are displayed on the LCD 38 of the image pickup apparatus 100 according to the exemplary embodiment, so that a user is able to visually specify the range of illumination. When the range of illumination is out of the angle of field, the range of illumination is not displayed as a matter of course.

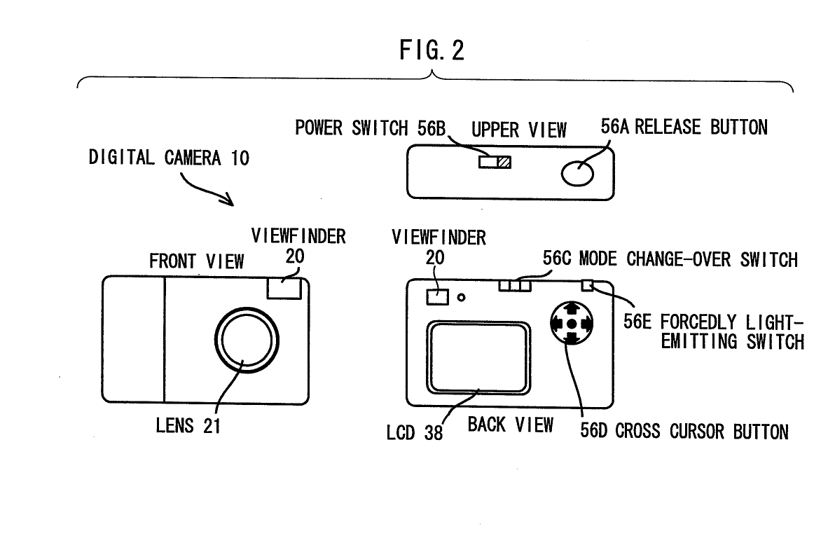

Referring now to FIG. 2, an appearance configuration of the digital camera 10 according to the exemplary embodiment will be described. Provided in the front of the digital camera 10 are a lens 21 as an optical member for forming an image of shooting object and a viewfinder 20 used for determining a picture composition of the shooting object to be shot. Provided on an upper surface of the digital camera 10 are a release button (so-called “shutter button”) 56A to be pressed to take a picture and a power switch 56B.

The release button 56A of the digital camera 10 according to the exemplary embodiment is configured to be capable of detecting two steps of pressing operation; a state of being pressed halfway (hereinafter, referred to as “halfway pressed state”) and a state of being pressed fully to the lowermost limit beyond the halfway position (hereinafter, referred to as “fully pressed state”).

According to the digital camera 10, the brightness of the shooting object is measured by pressing the release button 56A to the halfway pressed state, then, an AE (Automatic Exposure) function works to set an exposure state (shutter speed and a state of an aperture) according to the measured brightness of the shooting object, then, an AF (Auto Focus) function works to control the focus adjustment. When the release button 56A is pressed to the fully pressed state continuously from the halfway pressed state, the exposure (shooting) is carried out.

On the other hand, provided on the back surface of the digital camera 10 are an eye-piece of the viewfinder 20 described above, the LCD 38 for displaying the shot image of shooting object or a menu screen or the like and a mode change-over switch 56C which is to be slid when setting the mode between a shooting mode for carrying out shooting and a replay mode for redisplaying the image of the shooting object obtained by shooting on the LCD 38.

Provided also on the back surface of the digital camera 10 are a cross cursor button 56D and a forcedly light-emitting switch 56E to be pressed when setting a forcedly light-emitting mode which forces the strobe light 44 to emit light when shooting.

The cross cursor button 56D includes four arrow keys which indicate the directions of movement of upward, downward, leftward and rightward in a display area of the LCD 38, and a selection key existing at the center of the arrow keys.

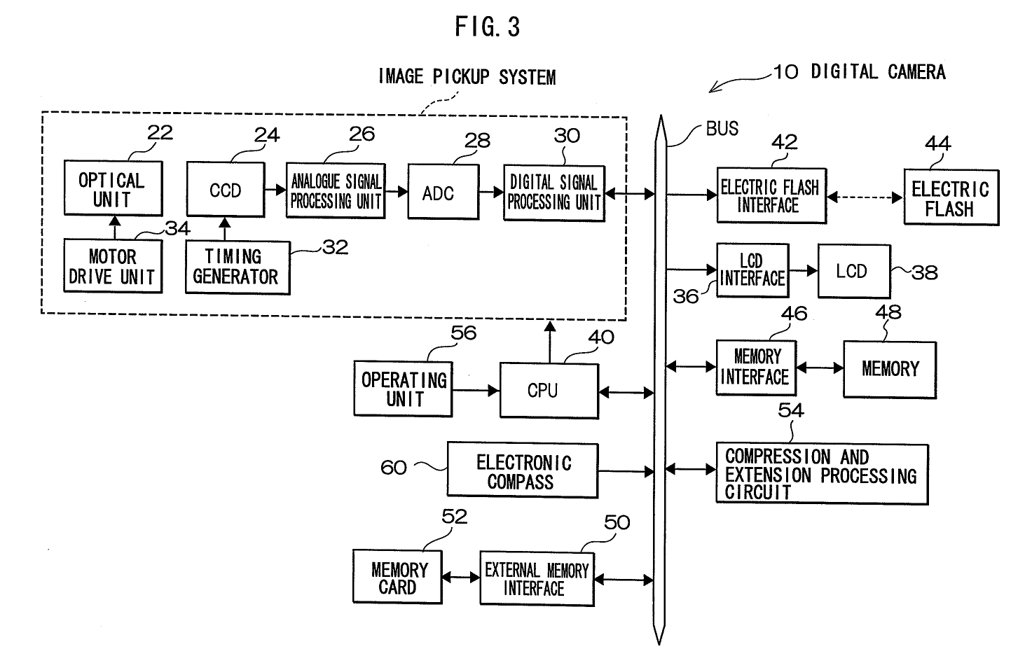

Subsequently, referring now to FIG. 3, a configuration of a principal portion of an electric system of the digital camera 10 according to the exemplary embodiment will be described.

The digital camera 10 includes an optical unit 22 including the aforementioned lens 21, a charge coupled device (hereinafter, referred to as “CCD”) 24 as an image pickup device disposed behind the optical axis of the lens 21 and an analog signal processing unit 26 for carrying out various analog signal processing for supplied analog signals. It is also possible to use a CMOS image sensor, a CCD of a honeycomb pixel arrangement, and a CCD of a Bayer system as the image pickup device.

The digital camera 10 includes an analog/digital (AD) converter (hereinafter, referred to as “ADC”) 28 for converting supplied analog signals to digital data, and a digital signal processing unit 30 for carrying out various digital signal processing for the supplied digital data.

The digital signal processing unit 30 includes a line buffer having a predetermined capacity integrated therein and executes control to record the supplied digital data directly in a predetermined area of a memory 48, described later as well.

The output end of the CCD 24 is connected to the input end of the analog signal processing unit 26, the output end of the analog signal processing unit 26 is connected to the input end of the ADC 28, and the output end of the ADC 28 is connected to the input end of the digital signal processing unit 30. Therefore, an analog signal which indicates the image of shooting object outputted from the CCD 24 is subjected to a predetermined analog signal processing by the analog signal processing unit 26, is converted into digital image data (hereinafter, it may be referred simply to as “image data”) by the ADC 28, and then is supplied to the digital signal processing unit 30.

The CCD 24, the analog signal processing unit 26, the ADC 28 and the digital signal processing unit 30 described above are included in an image pickup unit for picking up an image of a shooting object.

The digital camera 10 also includes a strobe light interface 42 for controlling light emission from the strobe light 44, an LCD interface 36 for generating a signal for displaying the image of shooting object, the menu screen on the LCD 38 and supplying the same to the LCD 38, an CPU (central processing unit) 40 for controlling the operation of the digital camera 10 as a whole, the memory 48 for storing the digital image data or the like obtained by shooting and a memory interface 46 for controlling the access to the memory 48. The strobe light interface 42 serves to communicate with the strobe light 44 through a fixed line or through wireless communication.

The digital camera 10 further includes an external memory interface 50 for making a portable memory card 52 to be accessible by the digital camera 10, a compression and extension processing circuit 54 for carrying out compression processing and extension processing on digital image data and an electronic compass 60 for obtaining the shooting direction of the digital camera 10. The electronic compass 60 outputs information indicating the shooting direction of the digital camera 10 through a three-axis magnetic sensor.

In the digital camera 10 according to the exemplary embodiment, a VRAM (Video RAM) is used as the memory 48, and a Smart Media (registered trademark) as the memory card 52.

The digital signal processing unit 30, the LCD interface 36, the CPU 40, the memory interface 46, the external memory interface 50 and the compression and extension processing circuit 54 are connected to each other via a system bus BUS. Therefore, the CPU 40 is capable of controlling operation of the digital signal processing unit 30 and the compression and extension processing circuit 54, displaying various information on the LCD 38 via the LCD interface 36, and accessing to the memory 48 and the memory card 52 via the memory interface 46 and the external memory interface 50.

On the other hand, the digital camera 10 is provided with a timing generator 32 for generating a timing signal mainly for driving the CCD 24 and supplying the same to the CCD 24, and driving of the CCD 24 is controlled by the CPU 40 via the timing generator 32.

The digital camera 10 is further provided with a motor drive unit 34, so that a focus adjusting motor, not shown, provided in the optical unit 22, a zoom motor and an aperture driving motor are also controlled by the CPU 40 via the motor drive unit 34.

In other words, the lens 21 according to the exemplary embodiment includes a plurality of pieces of lenses, and is configured as a zoom lens which is capable of changing the focal distance (variable power), and includes a lens drive mechanism, not shown. The lens drive mechanism includes the focus adjusting motor, the zoom motor and the aperture driving motor, and these motors are driven by drive signals supplied respectively from the motor drive unit 34 under the control of the CPU 40. In particular, the CPU 40 controls the opening aperture by the aperture driving motor to obtain an adequate exposure value.

The release button 56A, the power switch 56B, the mode change-over switch 56C, the cross cursor button 56D and the forcedly light-emitting switch 56E (in FIG. 2, they are shown collectively as an operating unit 56) described above are connected to the CPU 40, and the CPU 40 is capable of keeping track of the operating state with respect to the operating unit 56.

An operation of the digital camera 1 0 according to the exemplary embodiment at the time of shooting as a whole will be described in brief.

The CCD 24 carries out image pickup via the optical unit 22, and outputs analog signals for R (red), G (green) and B (blue) indicating the image of shooting object to the analog signal processing unit 26 in sequence. The analog signal processing unit 26 carries out the analog signal processing such as collated double sampling processing or the like on the analog signals supplied from the CCD 24, and outputs the same to the ADC 28 in sequence.

The ADC 28 converts the R,G,B analog signals supplied from the analog signal processing unit 26 to R,G,B signals respectively of 12 bits (digital image data) and outputs the same to the digital signal processing unit 30 in sequence. The digital signal processing unit 30 accumulates the digital image data supplied from the ADC 28 to the line buffer integrated therein in sequence and directly stores the same in the predetermined area in the memory 48 once.

The digital image data stored in the predetermined area of the memory 48 is read out by the digital signal processing unit 30, is subjected to white balance adjustment by being applied with digital gain according to a predetermined physical amount, and is also subjected to gamma processing and sharpness processing, thereby being converted into digital image data of a predetermined bit, for example, 8-bit, under the control of the CPU 40.

The digital signal processing unit 30 carries out YC signal processing on the digital image data converted into the predetermined bit to generate a luminance signal Y and chroma signals Cr, Cb (hereinafter referred to as “YC signals”), and stores the YC signals in an area different from the aforementioned predetermined area in the memory 48. The brightness of the shooting object is measured using the luminance signal Y generated here.

The LCD 38 is configured to be capable of displaying the through image and hence being used as a viewfinder as described above. When the LCD 38 is used as the viewfinder, the generated YC signals are outputted to the LCD 38 in sequence via the LCD interface 36. Accordingly, the through image is displayed on the LCD 38.

When the release button 56A is pressed to the halfway pressed state by a user, the AE function works to set the exposure state, and then the AF function works to control the focus adjustment as described above. When the release button 56A is pressed to the fully pressed state from the halfway pressed state, the YC signals stored in the memory 48 at this moment are compressed to a predetermined compression format (for example, JPEG format) by the compression and extension processing circuit 54, and stored in the memory card 52 via the external memory interface 50. Combined image data, described later, is stored in the memory card 52.

Hereinafter, the processing executed by the CPU 40 will be described using a flowchart. In the exemplary embodiment, a basic information acquiring process required for specifying the range of illumination of the strobe light 44 and a light intensity calculating process for calculating the light intensity of the strobe light 44 will be described.

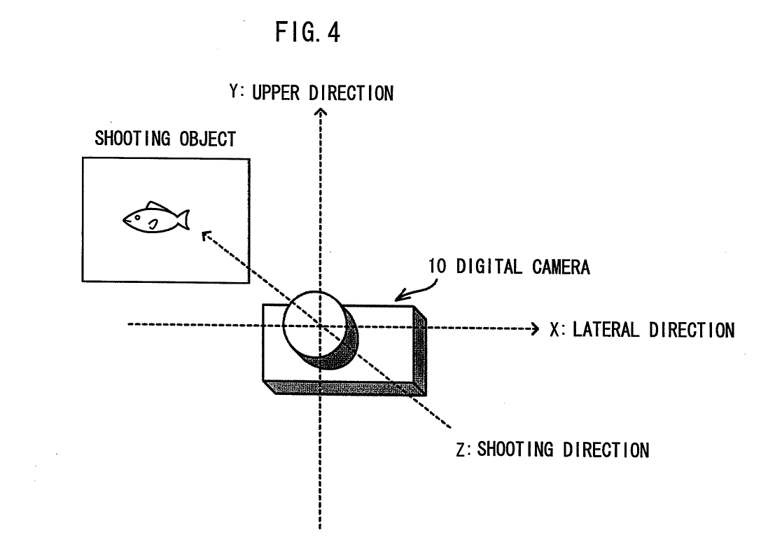

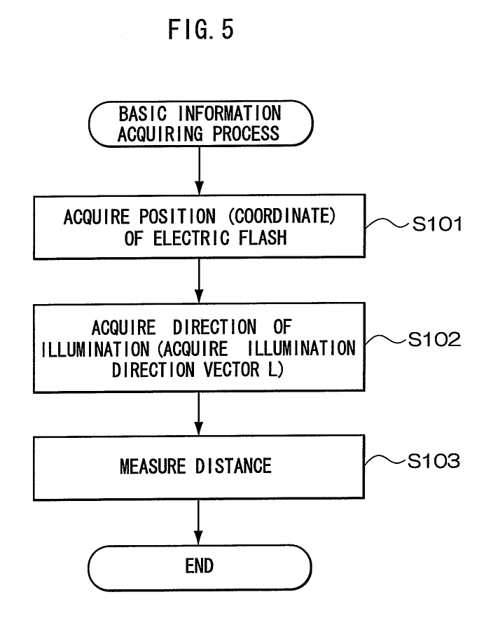

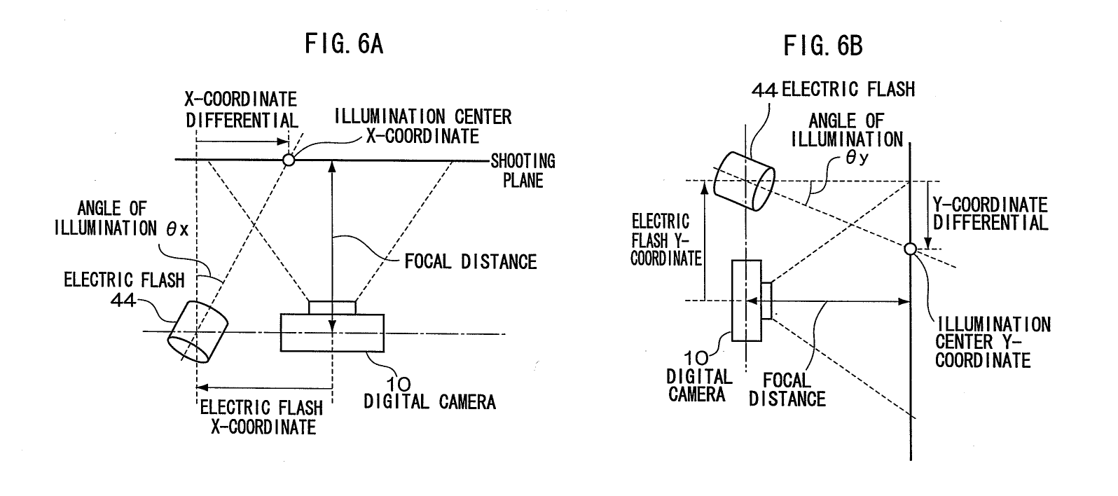

Firstly, referring to FIG. 4, FIG. 5, and FIGS. 6A and 6B, the basic information acquiring process will be described. In this process, a space including the digital camera 10 and the shooting object is processed as a three-dimensional space as illustrated in FIG. 4. As illustrated in FIG. 4, the shooting direction of the digital camera 10 is represented by a Z-axis, the upper direction of the digital camera 10 is represented by a Y-axis, and the lateral direction thereof is represented by an X-axis.

On the basis of these prerequisites, the basic information acquiring process will be described using a flowchart in FIG. 5. In Step 101, the position of the strobe light 44 will be acquired. The position of the strobe light 44 is expressed by a coordinate in the three-dimensional space. The position acquired in this case is a predetermined position since a relative positional relationship between the digital camera 10 and the strobe light 44 does not change in the case of the image pickup apparatus 100 illustrated in FIG. 1.

On the other hand, when the relative positional relationship between the digital camera 10 and the strobe light 44 changes, an ultrasonic wave transmitter is provided in the digital camera 10 in advance, and ultrasonic waves are emitted periodically from the ultrasonic wave transmitter. Then, the strobe light 44 is provided with a member which can reflect the ultrasonic wave with ease, or the ultrasonic wave may be emitted after a predetermined period since the ultrasonic wave emitted from the digital camera 10 is detected.

The digital camera 10 detects the ultrasonic waves from the strobe light 44 at three points and obtains the distance and the angle from the time difference of detection among these points, so that the relative position of the strobe light 44 is acquired.

When the position of the strobe light 44 is acquired in this manner, the direction of illumination is acquired in Step 102. The acquisition of the direction of illumination will be described using FIGS. 6A and 6B. FIG. 6A illustrates an XZ plane when viewing the image pickup apparatus 100 illustrated in FIG. 1 from above, and FIG. 6B illustrates a YZ plane when viewing the image pickup apparatus 100 from the side. The shooting planes illustrated in FIGS. 6A and 6B are planes which extend vertically with respect to the shooting direction so as to be at the same distance from the digital camera 10 and the shooting object.

As described above, a lateral angle (angle of illumination) θx and a vertical angle (angle of illumination) θy are detected by the strobe light 44, and these angles are notified to the digital camera 10, and hence an illumination direction vector L which indicates the direction of illumination is acquired. In this case, the electronic compass 60 described above is not necessary as a configuration of the digital camera 10.

On the other hand, when the relative positional relationship between the digital camera 10 and the strobe light 44 changes, an electronic compass for outputting information which indicates the direction by the aforementioned three-axis magnetic sensor is provided in the strobe light 44 in advance. The strobe light 44 outputs the information which indicates the direction of illumination outputted from the electronic compass to the digital camera 10. Then, the digital camera 10 acquires the illumination direction vector L indicating the direction of illumination by comparing the shooting direction outputted from the electronic compass 60 provided therein and the information of the electronic compass outputted from the strobe light 44.

When the direction of illumination is acquired on the basis of the information from the strobe light 44, the distance to the shooting object is measured in Step 103. This measurement of distance may be done by using the AF function, or by using a specific distance measurement sensor.

In FIGS. 6A and 6B, the strobe light X-coordinate indicates the X-coordinate of the strobe light 44, and the electronic flash Y coordinate indicates the Y-coordinate of the strobe light 44. The angle of illumination Ox indicates an angle formed when the vertical line from the strobe light 44 to the shooting plane and the direction of illumination are projected on the XZ plane. The angle of illumination θy indicates an angle formed when the vertical line from the strobe light 44 to the shooting plane and the direction of illumination are projected on the YZ plane.

The illumination center X-coordinate indicates an X-coordinate of an intersection of a line passing through the position of the strobe light 44 and extending in parallel to the direction of illumination and an illumination plane. In the same manner, the illumination center Y-coordinate indicates a Y-coordinate of the intersection of the line passing through the position of strobe light 44 and extending in parallel to the direction of illumination and the illumination plane. In the description shown below, the line passing through the strobe light 44 and extending in parallel to the direction of illumination is referred to as an illumination axis.

The X-coordinate differential indicates the distance from the X-coordinate at the intersection of the vertical line from the strobe light 44 to the shooting plane and the shooting plane to the illumination center X-coordinate. The Y-coordinate differential indicates the distance from the Y-coordinate of the intersection of the vertical line from the strobe light 44 to the shooting plane and the shooting plane to the illumination center Y-coordinate.

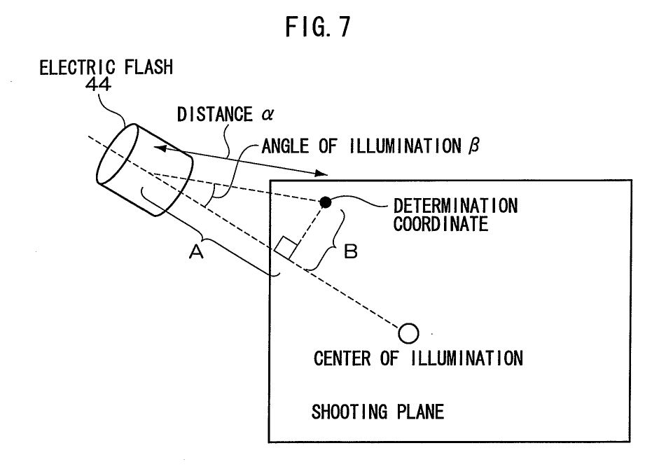

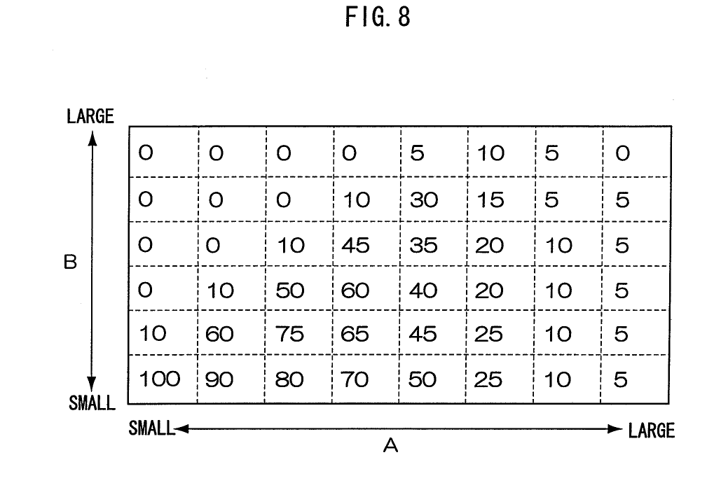

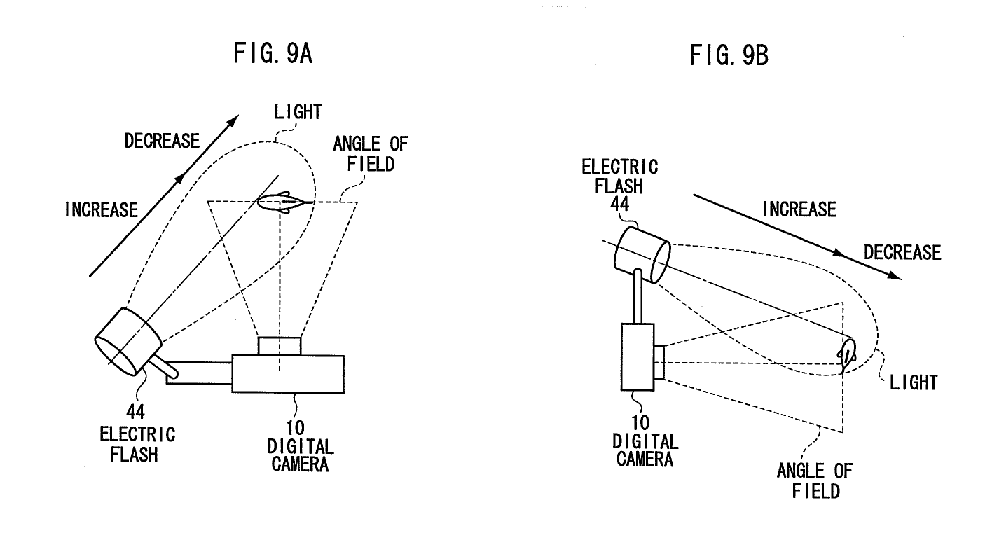

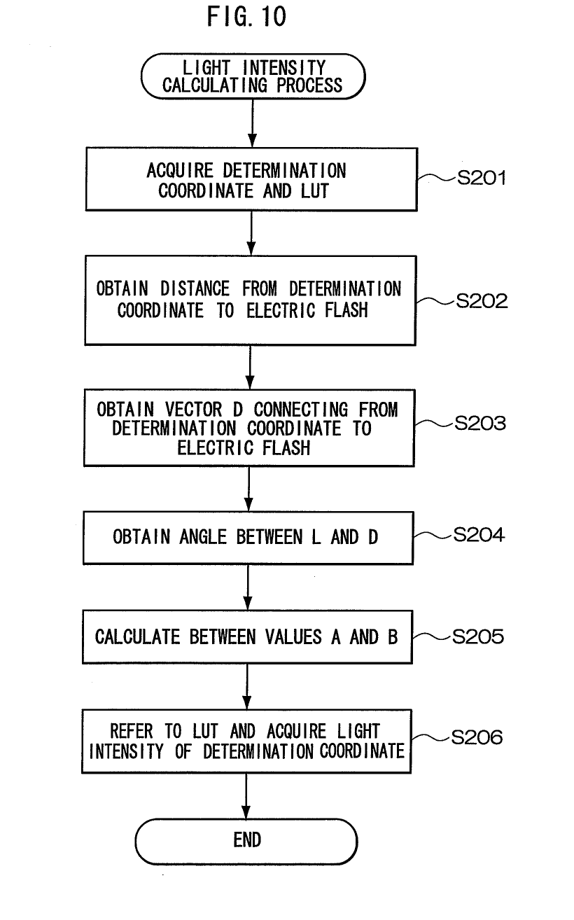

The process described thus far is the basic information acquiring process. Subsequently, referring to FIG. 7, FIG. 8, FIG. 9A, FIG. 9B and FIG. 10, the light intensity calculating process will be described.

Referring now to FIG. 7, a method of calculating values A and B, which are necessary for the light intensity calculating process will be described. In FIG. 7, the shooting plane and the strobe light 44 are illustrated, and on the shooting plane, a determination coordinate is shown. The determination coordinate is a point for determining the light intensity by the light intensity calculating process on the shooting plane. The value A is the distance from an intersection of a vertical line extending from the determination coordinate to the illumination axis and the illumination axis to the strobe light 44. The value B is the length of the vertical line extending from the determination coordinate to the illumination axis. An angle of illumination β is an angle formed between a segment connecting the determination coordinate and the strobe light 44 and the illumination axis. A distance a is the distance between the determination coordinate and the strobe light 44.

The angle of illumination β is obtained from an inner product of vector since the position, the determination coordinate and the illumination direction vector L of the strobe light 44 are known, and hence the distance a is also obtained. Therefore both of the values A and B are calculated.

After having obtained the values A and B in this manner, a lookup table (hereinafter, referred to as LUT) shown in FIG. 8 is referred to. The LUT is a table for acquiring the light intensity from the values A and B. The light intensity is expressed by 0% to 100%, and the larger value indicates the higher brightness. The 100% indicates that the determination coordinate is illuminated with light having the maximum intensity from the strobe light 44, and 0% indicates that the determination coordinate is little or not illuminated with light from the strobe light 44.

When the value A is large, it indicates that the position of the determination coordinate is far from the strobe light 44, and hence the light intensity is reduced. In the same manner, when the value B is large, it indicates that the position of the determination coordinate is far from the illumination axis, and hence the light intensity is reduced.

As shown in FIG. 8, the value B is changed in such a manner that the light intensity other than 0% increases first, and then decreases with increase of the value A. This point is described referring to FIG. 9A and FIG. 9B. FIG. 9A shows the image pickup apparatus 100 viewed from above, and FIG. 9B shows the image pickup apparatus 100 viewed from the side.

Both in FIGS. 9A and 9B, it is shown that light is spread in a conical shape, and hence the light intensity is reduced as it moves apart from the strobe light 44. Therefore, the value B has a characteristic in which the light intensity other than 0% increases first and then decreases in association with increase of the value A.

There are some types of LUTs other than the LUT shown in FIG. 8, and they have basically the characteristic as described above.

On the basis of these prerequisites, the light intensity calculating process will be described using a flowchart in FIG. 10. In Step 201, the determination coordinate and an LUT are acquired. The determination coordinate and the LUT are arguments set by the high function for calling up the light intensity calculating process. To acquire the LUT means to acquire a type of LUT to be used in the light intensity calculating process.

In Step 202, the distance a from the determination coordinate to the strobe light 44 is obtained. In Step 203, a vector D connecting the determination coordinate to the strobe light is obtained, and in Step 204, the angle (angle of illumination β) formed between the aforementioned illumination direction vector L and the vector D is obtained.

The values A and B are calculated from the angle of illumination β in Step 205, and the LUT is referred and the light intensity of the determination coordinate is acquired in Step 206.

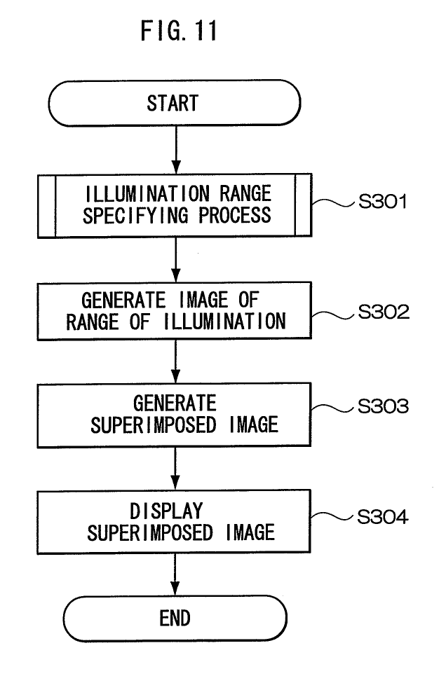

On the basis of the basic information acquiring process and the light intensity calculating process described above as prerequisites, the entire process in the exemplary embodiment will be described using a flowchart in FIG. 11.

In Step 301, an illumination range specifying process for specifying the range of illumination of the strobe light 44 is carried out. Here, the light intensities are stored for respective pixels corresponding to the shooting plane as pixel information. An image of the range of illumination, which presents the range of illumination specified by the illumination range specifying process, is generated in Step 302. In Step 302, since the light intensities described above are stored for the respective pixels, an image corresponding to the light intensities is generated. In generation of the image, an image colored by colors corresponding to the respective light intensities may be generated.

In Step 303, an image obtained by superimposing an image indicating the shooting object which was shot and the image of the range of illumination generated in Step 302 is generated. Then, in Step 304, the superimposed image is displayed on the LCD 38.

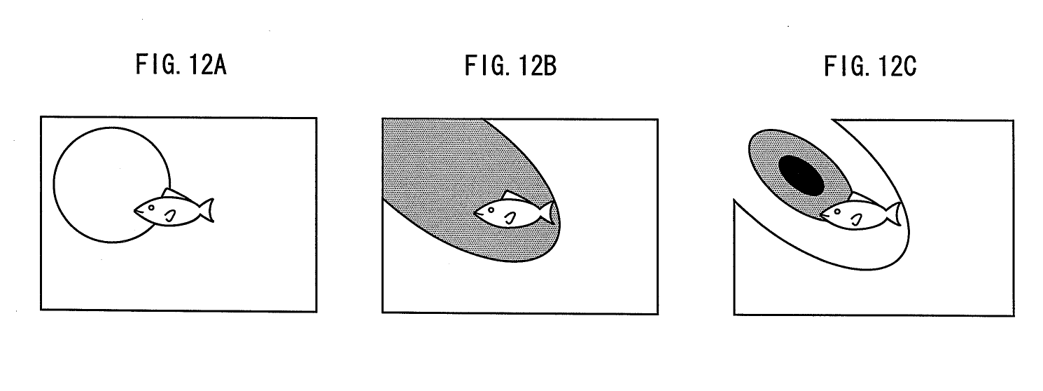

There are three methods of display as illustrated in FIGS. 12A, 12B and 12C in Step 304. FIG. 12A shows a display showing the range of illumination in a circle having the center at the illumination axis (hereinafter, referred to as “circular display”). In this method, the range of illumination is not indicated exactly, but the load of the light intensity calculating process is alleviated. FIG. 12B is a display in which the determination coordinates whose light intensity calculated in the light intensity calculating process is equal to or larger than a predetermined threshold value as the range of illumination (hereinafter, referred to as “simple display”). FIG. 12C shows a display in which the range of illumination displays distribution of the light intensity by the determination coordinates distinguished by colors according to the light intensities calculated in the light intensity calculating process (hereinafter, referred to as “distribution display”). The predetermined threshold value may be a value with which the shooting object is illuminated but at a very low brightness, or a value which is preset by the user. In FIG. 12C, the range of illumination is shown as the area in which the determination coordinates are distinguished by colors, but it is also possible to display only a frame and not by colors. In this manner in this exemplary embodiment, the distribution of the light intensity in the range of illumination may be displayed.

Referring now to the flowchart, the processes of carrying out the respective display methods will be described. Since the processes of carrying out the respective display methods depend only on the above described illumination range specifying process, only the illumination range specifying process will be described.

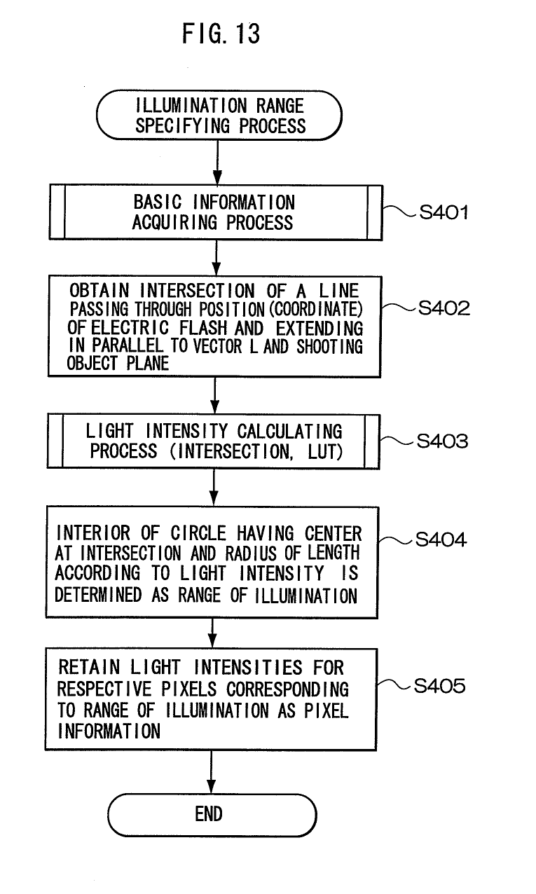

Referring to a flowchart in FIG. 13, the process in the case of the circular display will be described. In Step 401, the above-described basic information acquiring process is carried out. In Step 402, an intersection of the line passing through the position (coordinate) of the strobe light 44 and extending in parallel to the vector L and the shooting object plane is obtained. In Step 403, the light intensity calculating process is carried out. Here, the intersection and the LUT are provided as the arguments. Then, in Step 404, the interior of a circle having the center at the intersection and a radius of a length according to the light intensity calculated in Step 403 is determined to be a range of illumination having the same light intensity, and in Step 405, and the light intensity is retained as pixel information for the respective pixels corresponding to this range of illumination.

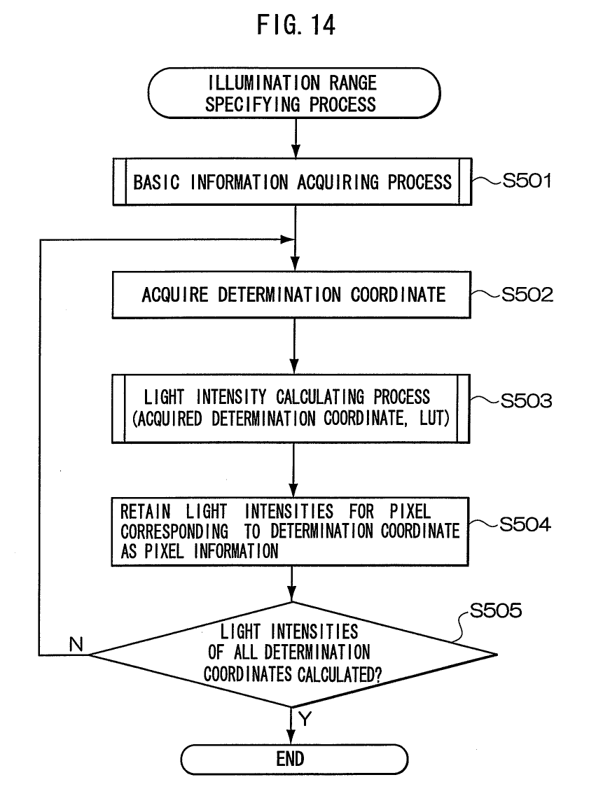

Referring to a flow chart in FIG. 14, the process in the case of the simple display or the distribution display will be described. In Step 501, the above-described basic information acquiring process is carried out. In Step 502, a determination coordinate is acquired. The determination coordinate acquired here is one of the coordinates within the shooting plane.

In Step 503, the light intensity calculating process is carried out. In this case, the determination coordinate acquired in Step 502 and the LUT are provided as the arguments. Then, in Step 504, the light intensity calculated in Step 503 is retained as pixel information for the pixel corresponding to the determination coordinate. In the case of the simple display, the light intensities equal to or higher than the predetermined threshold value are expressed by the same value such as 50% irrespective of the values thereof. In the case of a stepped display, the light intensities calculated in Step 503 may be retained as is, and in this case, the light intensities correspond to information on the light intensity distribution.

In Step 505, whether or not the light intensity of all the determination coordinates in the shooting plane are calculated is determined. If affirmative, the process is terminated, and if negative, the determination coordinates in the shooting plane whose light intensity is not calculated are acquired in Step 502.

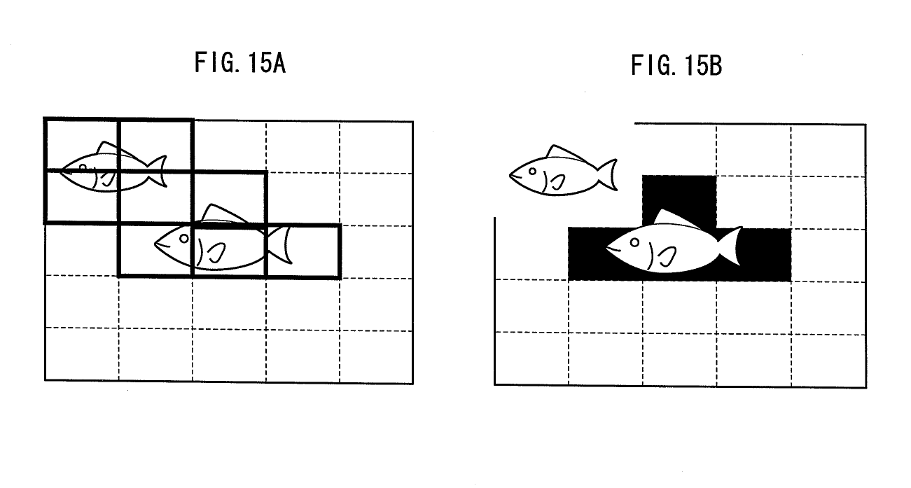

Since the light intensities of all the determination coordinates in the shooting plane must be calculated in the process described above, a load is exerted. Therefore, in order to alleviate the load, the determination coordinates are defined one per section obtained by dividing the image showing the interior of the shooting plane, that is, a shooting object, so that information showing whether the respective sections are to be illuminated or not is obtained, whereby the load is alleviated. In this case, images displayed on the LCD 38 are the images illustrated in FIGS. 15A and 15B. Rectangles each illustrated in FIGS. 15A and 15B indicate the divided sections. FIG. 15A shows an example of the simple display in which the range of illumination is surrounded by thick lines, and FIG. 15B shows an example of the stepped display in which the range of illumination is colored according to the light intensity.

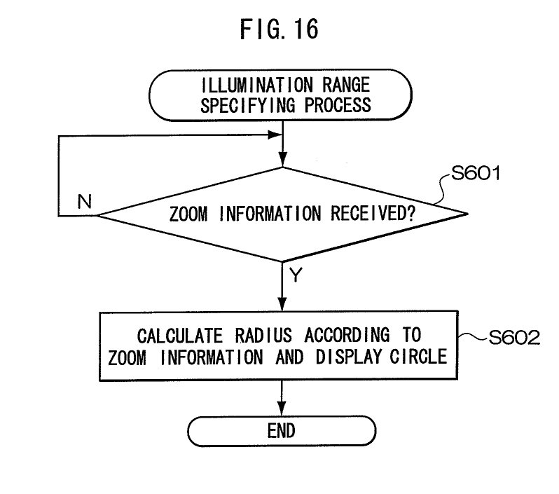

The process described below is a process to be carried out when the strobe light 44 has a zoom function for changing the size of the range of illumination. In this case, the strobe light 44 transmits the magnifying power to the digital camera 10 as zoom information every time when the magnifying power is changed. This process will be described using a flowchart in FIG. 16. The flowchart is carried out after having ended the process shown in FIG. 11 in which the process shown in FIG. 13 is carried out.

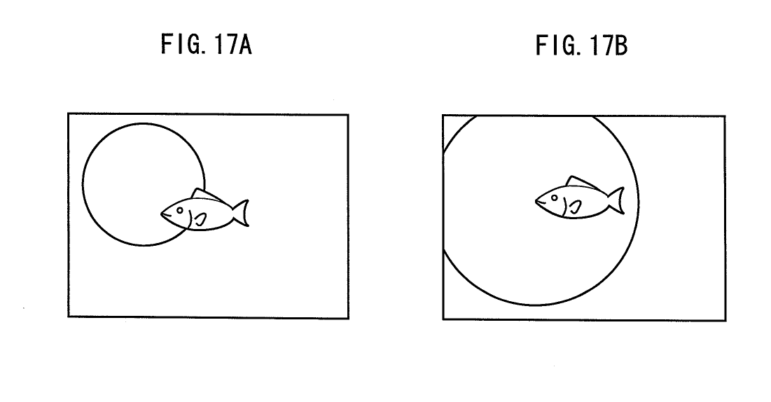

In Step 601, whether or not the zoom information is received is determined. If yes, the radius is calculated according to the zoom information and a circle having the radius is displayed in Step 602. Accordingly, as illustrated in FIGS. 17A and 17B, the range of illumination changed in conjunction with the size of the range of illumination of the strobe light 44 is displayed on the LCD 38. FIG. 17A shows an example of display in the case of being zoomed to a tele side, and FIG. 17B shows an example of display in the case of being zoomed to a wide side.

The process described below is a process to be carried out when displaying according to an image pickup sensitivity (ISO sensitivity). Even when the light intensity of the strobe light 44 is constant, the range of illumination for an image which is shot actually varies depending on the ISO sensitivity. Therefore, when the light intensity is constant, the range of illumination is small with a low ISO sensitivity and the range of illumination is wide with a high ISO sensitivity.

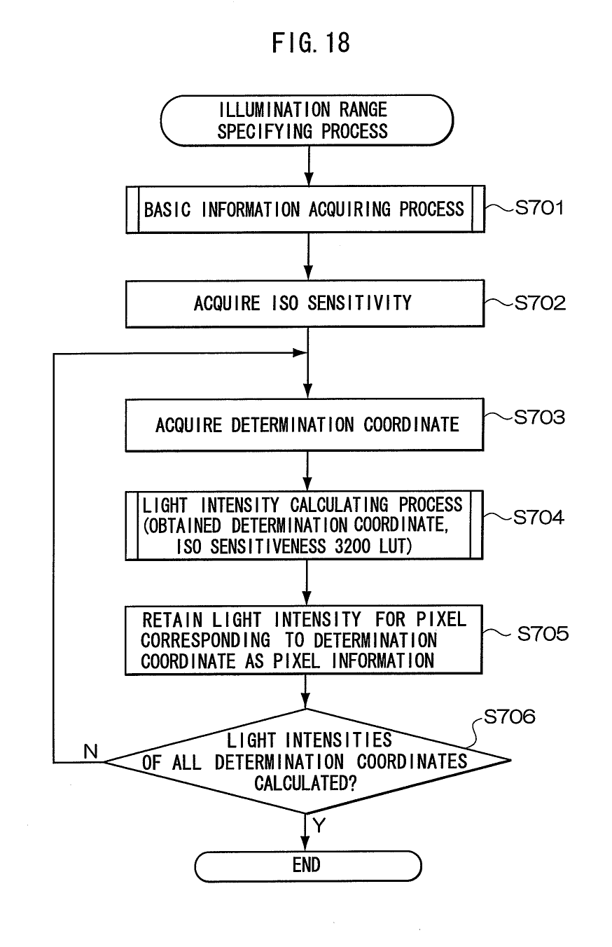

In this manner, the process to be carried out when displaying according to the ISO sensitivity will be described using a flowchart in FIG. 18.

In Step 701, the basic information acquiring process as described above will be carried out. In Step 702, the ISO sensitivity is acquired. The ISO sensitivity acquired here is assumed to be ISO 3200. The ISO sensitivity is retained in a predetermined area of the memory 48, the ISO sensitivity can be acquired by referring the memory 48. In Step 703, a determination coordinate is acquired. The determination coordinate acquired here is one of the coordinates in the shooting plane.

In Step 704, the light intensity calculating process is carried out. In this case, the determination coordinate acquired in Step 703 and the ISO 3200 LUT are passed as the arguments. The ISO 3200 LUT is the LUT in the case of ISO 3200, and is the LUT in which the light intensity is very low, and is 0% in comparison with the LUT shown in FIG. 8. The value ISO 3200 is exemplified in this case, it is needless to say that other values of ISO sensitivity are also applicable.

In Step 705, the light intensity calculated in Step 704 is retained in the pixel corresponding to the determination coordinate as pixel information. In Step 706, whether or not the light intensities of all the determination coordinates in the shooting plane are calculated is determined. If affirmative, the process is ended, and if negative, the determination coordinates in the shooting plane whose light intensity is not calculated are obtained in Step 703.

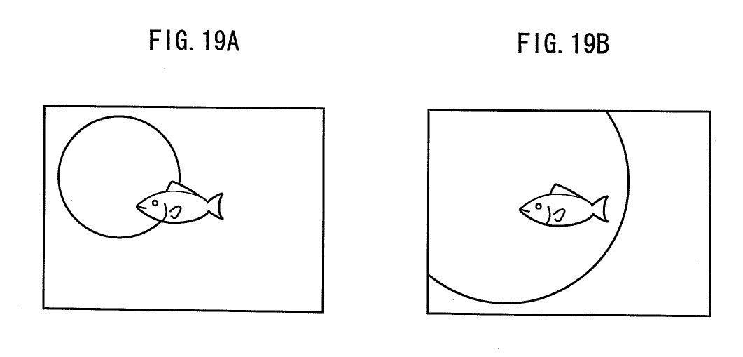

Accordingly, as illustrated in FIGS. 19A and 19B, the ranges of illumination according to the ISO sensitivity are displayed on the LCD 38. FIG. 19A shows an example of display in the case in which the ISO sensitivity is low, and FIG. 19B shows an example of display in the case in which the ISO sensitivity is high.

The process descried thus far needs the process using the coordinate, such as the basic information acquiring process and the light intensity calculating process. The process described below is different from the processes shown above, and is a process with a configuration in which the strobe light 44 for illuminating the range of illumination of the strobe light 44 is provided with an auxiliary lamp.

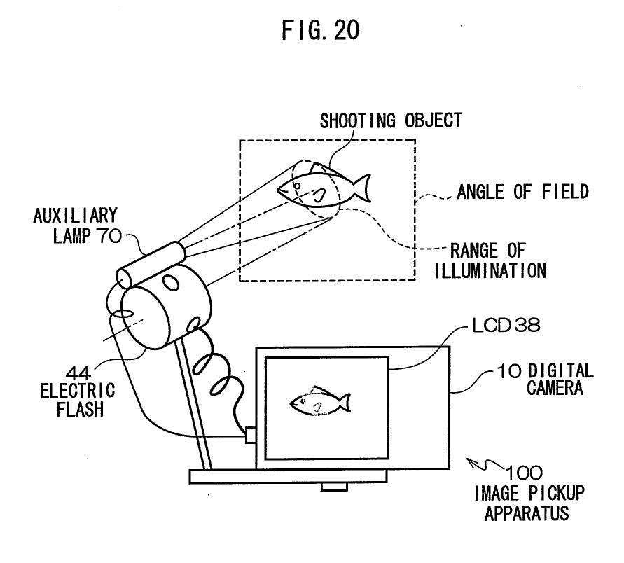

FIG. 20 shows a configuration in which an auxiliary lamp 70 is provided in addition to the configuration described in conjunction with FIG. 1. The auxiliary lamp 70 is adapted to blink periodically at a frequency synchronized with an image pickup cycle of the digital camera 10. In other words, bright images and dark images are displayed alternately on the LCD 38. The ratio of the bright images and the dark images does not have to be one for one.

A synchronizing signal for synchronizing with the image pickup cycle is transmitted to the auxiliary lamp 70 from the digital camera 10. As the illumination axis of the auxiliary lamp 70 is preferably positioned close to the illumination axis of the strobe light 44, the auxiliary lamp 70 may be provided in the interior of the strobe light 44 instead of providing outside the strobe light 44 as shown in the drawing.

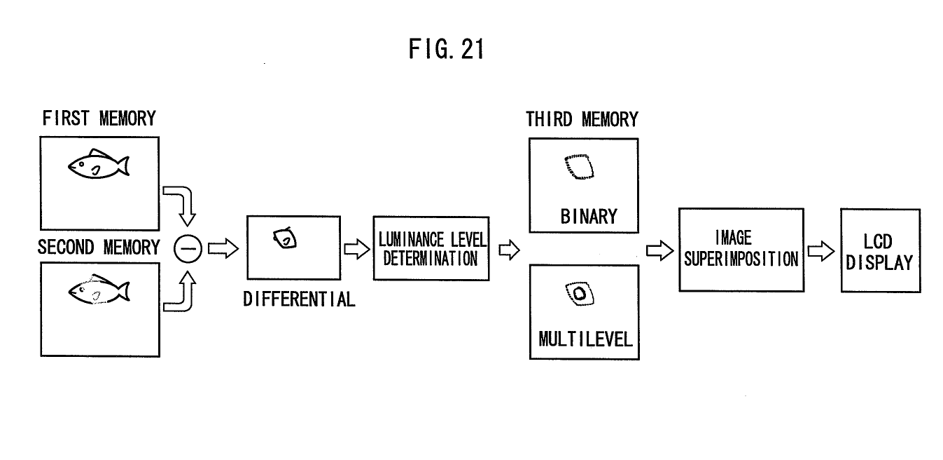

The process carried out in this configuration will be described using a block diagram shown in FIG. 21. First, second and third memories shown in FIG. 21 indicate areas provided in the area in the memory 48.

As shown in FIG. 21, image data picked up by an image pickup system (see FIG. 3) in a state in which the shooting object is not illuminated by the auxiliary lamp 70 is stored in the first memory, and image data picked up by the image pickup system in a state in which the shooting object is illuminated by the auxiliary lamp 70 is stored in the second memory. Image data stored in the respective memories may only be luminance components.

Then, the image data stored in the first memory is subtracted from the image data stored in the second memory from pixel to pixel to obtain the differential of the luminance component. The luminance level is determined for the differential to specify the range of illumination, and the specified range of illumination is binarized or multileveled, which is stored in the third memory. The image data stored in the third memory corresponds to the image of the range of illumination. When the range of illumination is multileveled, the level corresponds to the information on the light intensity distribution.

Then, the image of the shooting object and the image shown by the image data stored in the third memory are superimposed and are displayed on the LCD 38.

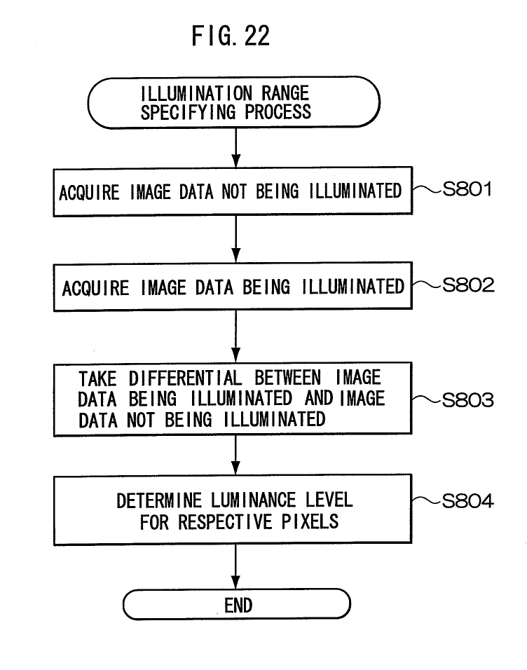

This process will be described using a flowchart in FIG. 22. This process depends only on the illumination range specifying process, and hence only the illumination range specifying process will be described.

In Step 801, the image data not being illuminated, which is the state in which the shooting object is not illuminated by the auxiliary lamp 70, is acquired, and is stored in the first memory. In Step 802, the image data being illustrated, which is the state in which the shooting object is illuminated by the auxiliary lamp 70, is acquired and is stored in the second memory. Then, in Step 803, as described above, the differential between the image data being illuminated and the image data not being illuminated is obtained and, in Step 804, the luminance levels are determined for the respective pixels.

The flows of the respective flowchart processes described thus far are illustrative only, and it is needless to say that counterchange of the sequence of the processes, addition of new steps, or deletion of unnecessary steps may be done without departing from the scope of the invention.

In the exemplary embodiment shown above, the case in which there is provided a single piece of the strobe light 44 has been described. However, this exemplary embodiment may be applied to a case in which a plurality of the strobe lights 44 are provided by carrying out the above-described processes for the respective strobe lights.

What is claimed is:

1. An image pickup apparatus comprising:
an image pickup unit that picks up an image of a shooting object;
an illuminating unit that illuminates the shooting object;
a specifying unit that specifies a range of illumination by the illuminating unit;
an illumination range image generating unit that generates an image of the range of illumination which shows the range of illumination specified by the specifying unit;
a superimposed image generating unit that generates an image by superimposing an image of the shooting object picked up by the image pickup unit and the image of the range of illumination generated by the illumination range image generating unit; and
a display unit that displays the superimposed image generated by the superimposed image generating unit.

2. The image pickup apparatus according to claim 1, further comprising:
a position acquiring unit that acquires the position of the illuminating unit;
an illumination direction acquiring unit that acquires the direction of illumination of the illuminating unit; and
a distance measuring unit that measures the distance between the shooting object and the image pickup apparatus; wherein
the specifying unit specifies the range of illumination on the basis of the position of the illuminating unit acquired by the position acquiring unit, the direction of illumination acquired by the illumination direction acquiring unit and the distance measured by the distance measuring unit.

3. The image pickup apparatus according to claim 2, further comprising an image pickup sensitivity acquiring unit that acquires an image pickup sensitivity of the image pickup unit, wherein
the specifying unit specifies the range of illumination on the basis of the image pickup sensitivity acquired by the image pickup sensitivity acquiring unit.

4. The image pickup apparatus according to claim 2, wherein the information on the range of illumination is information obtained by dividing the image of shooting object into sections and indicates by section whether or not the image of the shooting object acquired by the image pickup unit is illuminated.

5. The image pickup apparatus according to claim 3, wherein the information on the range of illumination is information obtained by dividing the image of shooting object into sections and indicates by section whether or not the image of the shooting object acquired by the image pickup unit is illuminated.

6. The image pickup apparatus according to claim 1, further comprising an auxiliary illuminating unit that illuminates the range of illumination, wherein
the specifying unit specifies the range of illumination on the basis of the image picked up by an image pickup unit in a state in which the shooting object is illuminated by the auxiliary illuminating unit and an image picked up by the image pickup unit in a state in which the shooting object is not illuminated by the auxiliary illuminating unit.

7. The image pickup apparatus according to claim 2, wherein:
the information on the range of illumination includes light intensity distribution information that indicates a distribution of the light intensity within the range of illumination; and
the display unit displays the distribution of the light intensity within the range of illumination on the basis of the light intensity distribution information.

8. The image pickup apparatus according to claim 3, wherein:
the information on the range of illumination includes light intensity distribution information that indicates a distribution of the light intensity within the range of illumination; and
the display unit displays the distribution of the light intensity within the range of illumination on the basis of the light intensity distribution information.

9. The image pickup apparatus according to claim 4, wherein:
the information on the range of illumination includes light intensity distribution information that indicates a distribution of the light intensity within the range of illumination; and
the display unit displays the distribution of the light intensity within the range of illumination on the basis of the light intensity distribution information.

10. The image pickup apparatus according to claim 6, wherein:
the information on the range of illumination includes light intensity distribution information that indicates a distribution of the light intensity within the range of illumination; and
the display unit displays the distribution of the light intensity within the range of illumination on the basis of the light intensity distribution information.

11. The image pickup apparatus according to claim 2, wherein:
the illuminating unit is capable of changing the size of the range of illumination by the illuminating unit; and
the size of the range of illumination indicated by the information on the range of illumination is changed in conjunction with the size of the range of illumination by the illuminating unit.

12. The image pickup apparatus according to claim 3, wherein:
the illuminating unit is capable of changing the size of the range of illumination illuminated by the illuminating unit; and
the size of the range of illumination indicated by the information on the range of illumination is changed in conjunction with the size of the range of illumination by the illuminating unit.

13. The image pickup apparatus according to claim 4, wherein:
the illuminating unit is capable of changing the size of the range of illumination illuminated by the illuminating unit; and
the size of the range of illumination indicated by the information on the range of illumination is changed in conjunction with the size of the range of illumination by the illuminating unit.

14. The image pickup apparatus according to claim 6, wherein:
the illuminating unit is capable of changing the size of the range of illumination illuminated by the illuminating unit; and
the size of the range of illumination indicated by the information on the range of illumination is changed in conjunction with the size of the range of illumination by the illuminating unit.

15. The image pickup apparatus according to claim 7, wherein:
the illuminating unit is capable of changing the size of the range of illumination illuminated by the illuminating unit; and
the size of the range of illumination indicated by the information on the range of illumination is changed in conjunction with the size of the range of illumination by the illuminating unit.
